(19) United States
(12) Patent Application Publication
(10) Pub. No.: US 2024/0104484 A1
(43) Pub. Date: Mar. 28, 2024

(54) SYSTEMS AND METHODS FOR NEXT GENERATION CONNECTED-WORKER SOLUTIONS FOR OCCUPATIONAL SAFETY, HEALTH, AND PRODUCTIVITY

(71) Applicant: Honeywell International Inc., Charlotte, NC (US)

(72) Inventors: Sivakumar KANAGARAJAN, Madurai (IN); Gobinathan BALADHANDAPANI, Madurai (IN); Wade LINDSEY, Canton, GA (US)

(21) Appl. No.: 18/063,609

(22) Filed: Dec. 8, 2022

(30) Foreign Application Priority Data
Sep. 28, 2022 (IN) 202211055677

(51) Int. Cl. G06Q 10/0639; G06Q 10/0631

(52) U.S. Cl. CPC G06Q 10/06398; G06Q 10/063114

(57) ABSTRACT

Disclosed are methods and systems for identifying alerts relating to a connected system. The method may include receiving assessment data from one or more devices, validating received environment information and received user information of the assessment data based on additional data received from one or more additional devices other than the one or more devices, collecting task data from the one or more devices and the one or more additional devices while the at least one user performs the at least one task associated with the one or more devices, analyzing the collected task data to determine if the collected task data indicates at least one violation by comparing the collected task data to one or more thresholds, and displaying one or more alerts on one or more user interfaces of one of the devices, the one or more alerts including information indicating the at least one violation.

### CROSS-REFERENCE TO RELATED APPLICATION(S)

This patent application claims the benefit of priority to Indian Application No. 202211055677, filed Sep. 28, 2022, which is incorporated herein by reference in its entirety.

### TECHNICAL FIELD

Various embodiments of the present disclosure relate generally to methods and systems to optimize operations in a workplace such as a warehouse, distribution center, airport ground operations, and retail generally.

### BACKGROUND

Workplaces come with many inherent distractions and risks. In order to protect workers, as well as protect the physical, mental, and economic well-being of workers and the workplace, it is important to be able to identify and remediate the potential risk factors in the workplace. Moreover, the ability to quickly identify and remediate the potential risk factors is important for the safety, health, productivity, and work efficiency of the workers. Conventional techniques do not allow for the real-time monitoring (and decision making) of workplace assets. Additionally, conventional techniques lack the ability to efficiently schedule tasks based on the task and worker characteristics to avoid potential risk factors. Thus, there exists a need to efficiently identify and remediate the potential risk factors in a workplace.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for identifying one or more alerts relating to a connected system.

In one aspect, an exemplary embodiment of a method for identifying one or more alerts relating to a connected system is disclosed. The method may include receiving, by one or more processors, assessment data from one or more devices, the assessment data including (i) environment information corresponding to at least one environment of the one or more devices, (ii) task information corresponding to at least one task associated with the one or more devices, and (iii) user information corresponding to at least one user of the one or more devices. The method may further include validating, by the one or more processors, the received environment information and the received user information of the assessment data based on additional data received from one or more additional devices other than the one or more devices. The method may further include collecting, by the one or more processors, task data from the one or more devices and the one or more additional devices while the at least one user performs the at least one task associated with the one or more devices. The method may further include analyzing, by the one or more processors, the collected task data to determine if the collected task data indicates at least one violation by comparing the collected task data to one or more thresholds, the at least one violation including at least one of: an environment violation or a health violation, or a task violation. The method may further include displaying, by the one or more processors, one or more alerts on one or more user interfaces of one of the devices, the one or more alerts including information indicating the at least one violation.

In one aspect, a computer system for identifying one or more alerts relating to a connected system is disclosed. The computer system may include a memory having processor-readable instructions stored therein, and one or more processors configured to access the memory and execute the processor-readable instructions, which when executed by the one or more processors configures the one or more processors to perform a plurality of functions. The functions may include receiving assessment data from one or more devices, the assessment data including (i) environment information corresponding to at least one environment of the one or more devices, (ii) task information corresponding to at least one task associated with the one or more devices, and (iii) user information corresponding to at least one user of the one or more devices. The functions may further include validating the received environment information and the received user information of the assessment data based on additional data received from one or more additional devices other than the one or more devices. The functions may further include collecting task data from the one or more devices and the one or more additional devices while the at least one user performs the at least one task associated with the one or more devices. The functions may further include analyzing the collected task data to determine if the task data indicates at least one violation by comparing the collected task data to one or more thresholds, the at least one violation including at least one of: an environment violation, a health violation, or a task violation. The functions may further include displaying one or more alerts on one or more user interfaces of one of the devices, the one or more alerts including information indicating the at least one violation.

In one aspect, a non-transitory computer-readable medium containing instructions for identifying one or more alerts relating to a connected system is disclosed. The instructions may include receiving assessment data from one or more devices, the assessment data including (i) environment information corresponding to at least one environment of the one or more devices, (ii) task information corresponding to at least one task associated with the one or more devices, and (iii) user information corresponding to at least one user of the one or more devices. The instructions may further include validating the received environment information and the received user information of the assessment data based on additional data received from one or more additional devices other than the one or more devices. The instructions may further include collecting task data from the one or more devices and the one or more additional devices while the at least one user performs the at least one task associated with the one or more devices. The instructions may further include analyzing the collected task data to determine if the task data indicates at least one violation by comparing the collected task data to one or more thresholds, the at least one violation including at least one of: an environment violation, a health violation, or a task violation. The instructions may further include displaying one or more alerts on one or more user interfaces of one of the devices, the one or more alerts including information indicating the at least one violation.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic diagram illustrating an example environment implementing methods and systems of this disclosure, according to one or more embodiments.

FIG. 2A is a diagram of architecture of a connected warehouse system of this disclosure, according to one or more embodiments.

FIG. 2B is a diagram of a layout of a warehouse with the connected warehouse system of this disclosure, according to one or more embodiments.

FIG. 3 is a flowchart illustrating a method for optimizing operations of a job site, according to one or more embodiments.

FIG. 4 depicts a flowchart of an exemplary method for providing real-time connected system solutions, according to one or more embodiments.

FIG. 5 depicts a flowchart of an exemplary method for identifying one or more alerts relating to a connected system, according to one or more embodiments.

FIG. 6 is a diagram of architecture of a connected warehouse system of this disclosure, according to one or more embodiments

FIG. 7 is a diagram of architecture of a connected warehouse system of this disclosure, according to one or more embodiments.

FIG. 8 depicts a schematic block diagram of a framework of a platform of a connected warehouse system, according to one or more embodiments.

FIG. 9 depicts an example system that may execute techniques presented herein.

### DETAILED DESCRIPTION OF EMBODIMENTS

According to certain aspects of the disclosure, methods and systems are disclosed for identifying one or more alerts relating to a connected system. Conventional techniques may not be suitable at least because conventional techniques, among other things, do not allow for pre-planning of tasks based on task and worker characteristics. Additionally, conventional techniques may not provide the ability to mitigate risk in a real-time context. Accordingly, improvements in technology relating to analyzing a connected system and identifying security alerts are needed.

Workplace incidents may have a meaningful impact on the physical, mental, and economic well-being of workers and their families. Additionally, such incidents may also cause various burdens on a company (e.g., medical insurance premiums, lost productivity, and/or the costs of hiring/training replacements). As a result, there is a demand for mitigating workplace risk by pre-planning tasks based on the task and worker characteristics. There is also a demand for monitoring, managing, and optimizing workplace assets based on real-time context.

Advantages of such a system may include increasing workplace safety, as well as mitigating and eliminating risk. Additional advantages may include increasing efficiency and productivity of workers by pre-planning tasks, as well as reducing safety risks. Other advantages may include the ability to continuously improve workplace safety by tracking information related to tasks, safety equipment used when performing the tasks, and safety outcomes. Tracking such information may allow for the system to make future modifications and continuously improve.

The systems and methods disclosed herein relate to identifying one or more alerts relating to a connected system. The systems and methods may include receiving, by one or more processors, assessment data from one or more devices, the assessment data including (i) environment information corresponding to at least one environment of the one or more devices, (ii) task information corresponding to at least one task associated with the one or more devices, and (iii) user information corresponding to at least one user of the one or more devices. The systems and methods may further include validating, by the one or more processors, the received environment information and the received user information of the assessment data based on additional data received from one or more additional devices other than the one or more devices. The systems and methods may further include collecting, by the one or more processors, task data from the one or more devices and the one or more additional devices while the at least one user performs the at least one task associated with the one or more devices. The systems and methods may further include analyzing, by the one or more processors, the collected task data to determine if the collected task data indicates at least one violation by comparing the collected task data to one or more thresholds, the at least one violation including at least one of: an environment violation or a health violation, or a task violation. The systems and methods may further include displaying, by the one or more processors, an alert on one or more user interfaces of one of the devices, the alert including information indicating the at least one violation.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, relative terms, such as, for example, “about,” “substantially,” “generally,” and “approximately” are used to indicate a possible variation of ±10% in a stated value. The term “exemplary” is used in the sense of “example” rather than “ideal.” As used herein, the singular forms “a,” “an,” and “the” include plural reference unless the context dictates otherwise.

### Exemplary Environment

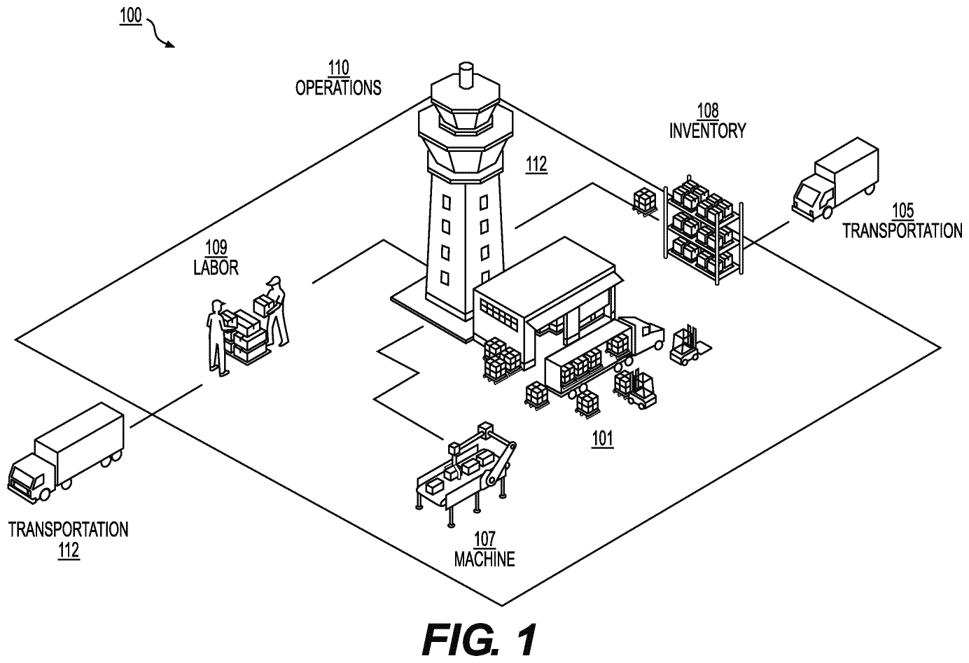

FIG. 1 illustrates an exemplary warehouse and/or distribution center environment 100 with certain components, including delivery transportation 105 (e.g., supply chain delivery truck) to load into inventory 108. An operational control tower 112 may monitor and/or otherwise control operations 110 within environment 100. Operations 110 can be performed and/or managed by labor 109. Operations 110 can include loading 101 and assembly machines 107. Once assembled, packaged, and otherwise processed for distribution, transportation 116 (e.g., a freight truck) can be loaded by labor 109 and depart for its subsequent destination. The environment 100 is configured to optimize worker performance by selectively scheduling and assigning tasks and worker equipment, as discussed more particularly below. The terms “worker” and “user” can be understood as a human, a non-human animal (e.g., a trained animal such as a dog) or any other asset that performs tasks at a job site (e.g., a robotic device).

### Exemplary Connected Warehouse System Architecture

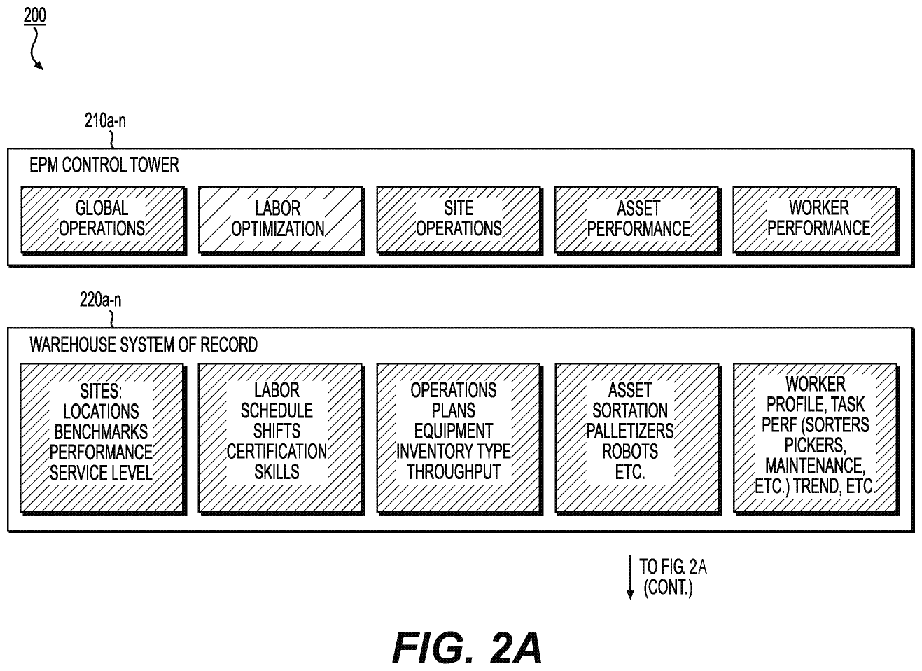

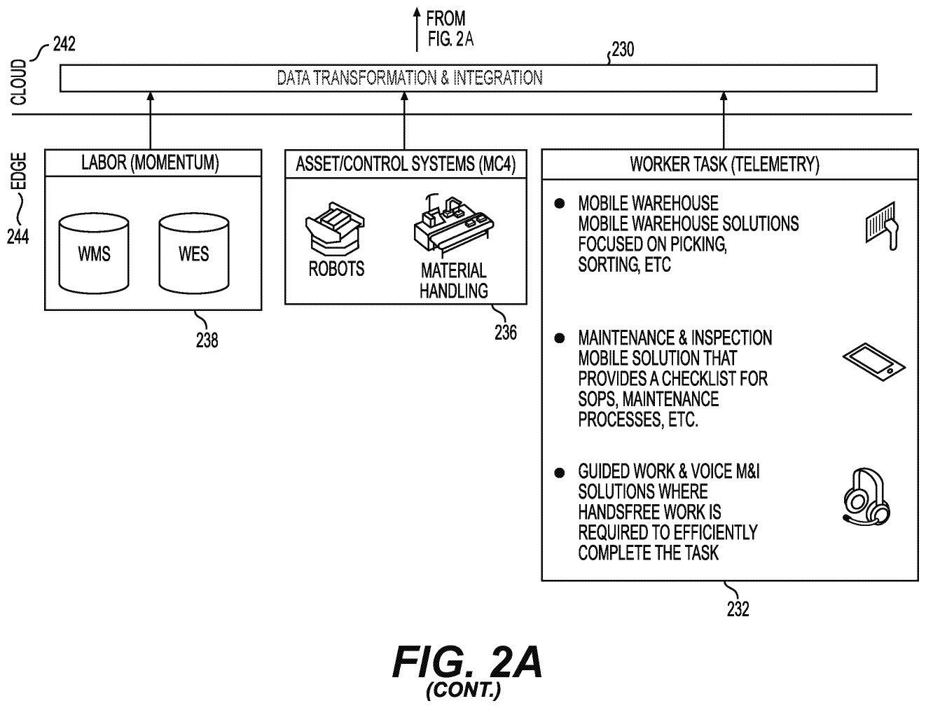

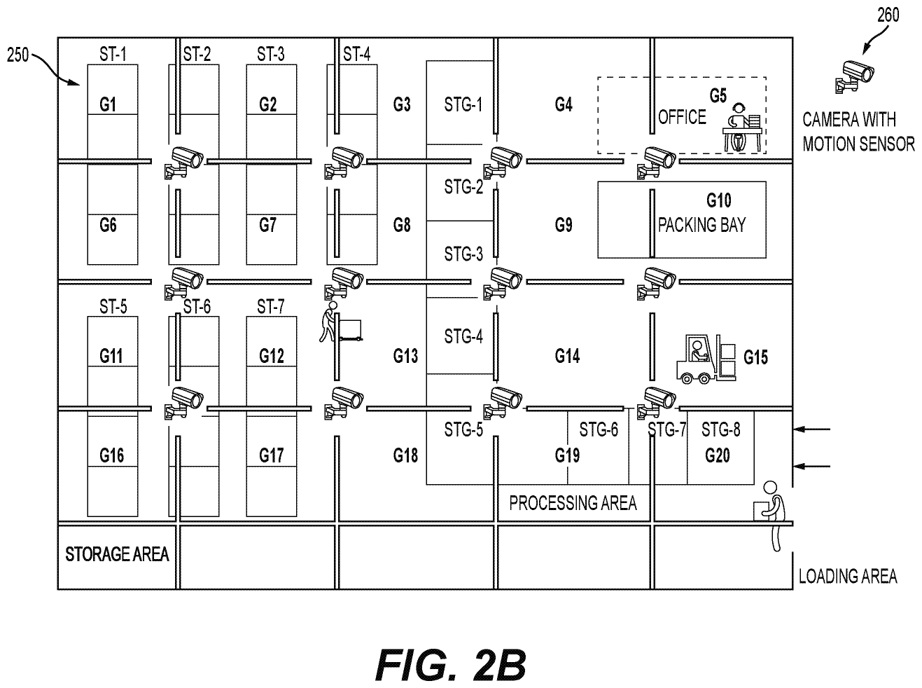

FIG. 2A illustrates a diagram of architecture associated with a connected warehouse system 200 of this disclosure. System 200 may include enterprise performance management (EPM) control tower 210a-n, including components and databases such as, but not limited to, global operations, labor optimization, site operations, asset performance, and worker performance. System 200 may also include a networked warehouse system of record 220a-n, including components and databases such as, but not limited to, sites (e.g., locations, benchmarks, performance service level, etc.), labor (e.g., schedule, shifts, certification, skills, etc.), operations (e.g., plans, equipment, inventory type, throughput, etc.), assets (e.g., sortation, palletizers, robots, etc.), and/or workers (e.g., trends, profiles, task performance such as sorters, pickers, maintenance works, etc.). EPM control tower 210a-n and networked warehouse system of record 220a-n can reside in a cloud based computing system 242 (e.g., a cloud computing network, one or more remote servers) and be communicatively coupled to forge data transformation and integration layer 230.

System 242 may be communicatively coupled to an edge computing system 244. System 244 can be an edge computing system or node with a dedicated unit onsite at the work site (e.g., factory, distribution center, warehouse, etc.). System 244 can be configured to process data and information from labor database 238, asset control systems 236 (e.g., components related to control of robots, material handling, etc.) and worker tasks database 232. Database 238 can include databases for warehouse management services (WMS) and warehouse execution systems (WES).

Database 232 can include one or more telemetry components operatively coupled to features of distribution center environment 100 to process and transmit control information, the incoming control information for consumption by one or more controllers of system 240 over a network. Database 232 can be configured for data validation and modification for incoming telemetry or attributes before saving to the database; copy telemetry or attributes from devices to related assets so the telemetry may be aggregated (e.g., data from multiple subsystems can be aggregated in related assets); create/update/clear alarms based on defined conditions; trigger actions based on edge life-cycle events (e.g., create alerts if device is online/offline); load additional data required for processing (e.g., load threshold value for a device that is defined in a user, device, and/or employee attribute); raise alarms/alerts when complex event occurs and use attributes of other entities inside email template; and/or consider user preferences during event processing. In some aspects, messages transmitted from database 232, such as triggers and/or alerts, can be configured for transmitting information to an end user (e.g., site lead, crew in the control tower, etc.) for optimization purposes. System 200 can also be configured to detect near accidents or other misses to build a trend model for early detection of anomalies before faults or malfunctions occur, thus increasing safety. In some aspects, the trend model can perform statistical analysis of worker trends including assigned tasks, event datasets to derive insights on worker performance considering the nature of work, skillset, criticality, labor intensity, etc. In some aspects, the trend model can classify data on a variety of key performance parameters to generate reports, dashboards, and insights that can be presented to users. In some aspects, the trend model can determine benchmarks based on statistics for type of task, skill set, geographical location, industry, and the like to enable performance-based assessment, incentives, and target setting for worker operations.

Database 232 can include mobile warehouse solutions focused on picking, sorting, and other such tasks. Database 232 can include maintenance and inspection components configured to provide one or more checklists with standard operating procedures (SOPs), maintenance processes, and the like. Database 232 can include guided work, as well as voice maintenance and inspection components where hands-free work may be required by employees to complete a task.

FIG. 2B is a diagram of a layout of a warehouse with the connected warehouse system described in FIG. 2A. The warehouse may include a job site 250 that may comprise, for example, a storage area, a processing area, a loading area, a packing bay, and/or an office. Workers are generally situated in the storage area, the processing area, the loading area, and/or the packing bay, depending on their assigned tasks. Meanwhile, managers and supervisors may generally be in the office away from at least a majority of the workers. As such, managers and supervisors may have difficulty directly evaluating the engagement of their workers.

The warehouse system 200 described in FIG. 2A may be used to evaluate the engagement of workers against their assigned tasks using a variety of sources including voice input, scanning, device usage, network activity, location-based events, and/or visual recognition events. The input from these sources may be fed to algorithms that identify cases where workers are not fully engaged or not making expected progress against their assignments or tasks.

The system 200 may employ a plurality of methods to track the real-time progress of the tasks. The system may interface with external systems to track the engagement levels of the workers on a real-time basis. This may include tracking specific task scheduled start times, the progress of the task after it has commenced, and/or a completion of the task. The warehouse layout may be equipped with motion sensor cameras 260 at strategic locations to monitor the movement of workers and materials in the warehouse. Each task may be broken down to various stages and each stage associated with desirable time for completion. The time duration of each stage may be based on historic performance of workers, distance, level of effort involved, and company or regulatory practices/policies. The motion sensing cameras may capture the worker and material movement and then automatically compute the status of the task based on the position of the worker and the materials. The worker may also be provided with voice or PED based application that may track and collect information directly from the worker on the progress made.

Since the system 200 also interfaces with external systems for real-time tracking of other events, anomalies, or failures in the business environment, which potentially impact the productivity of the worker, the system 200 may include an algorithm to identify idle and/or unproductive workers. The algorithm may also compare such idle and/or unproductive workers to events that may impact their tasks. If there is no event identified that may explain a worker's idleness, a communication may be triggered to the worker to identify whether there has been a localized or personal incident, such as a medical event or fatigue.

### Exemplary System Flow for Optimizing Operations of a Job Site

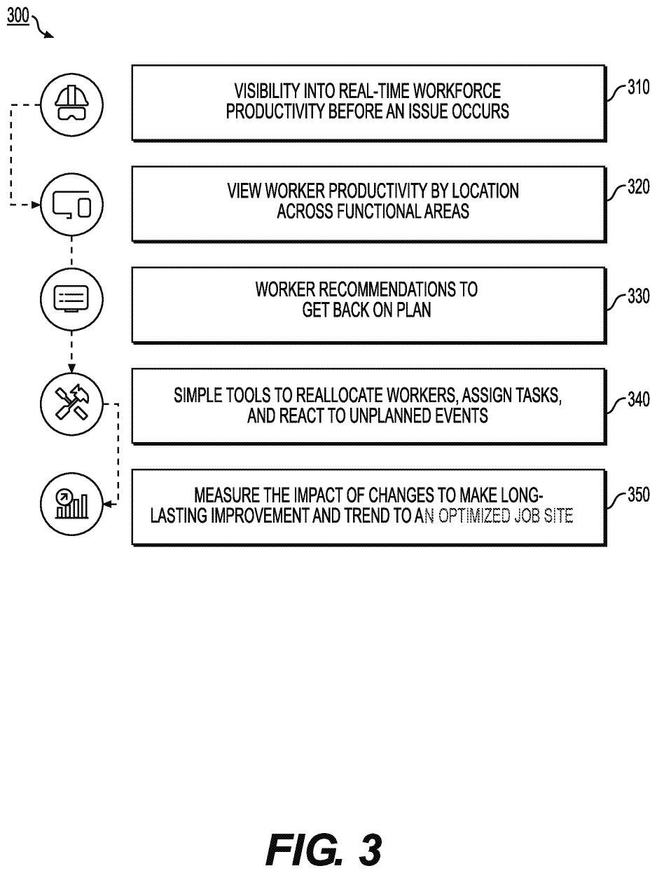

FIG. 3 is a flowchart illustrating a method 300 for optimizing operations of a job site, according to one or more embodiments. In step 310, the method may include providing visibility into real-time workforce productivity before an issue occurs. In step 320, the method may include viewing worker productivity by location across functional areas. In step 330, the method may include providing worker recommendations to return to a worker plan. In step 340, the method may include providing tools to reallocate workers, assignment tasks, and/or react to unplanned events. The reallocation of workers or tasks may be in response to identifying a surplus of idle workers on one task or in one space, and a lack of available workers on another task or in another space. In step 350, the method may include measuring the impact of changes to make persistent improvements and trend to an optimized job site.

Although FIG. 3 shows example blocks of exemplary method 300, in some implementations, the exemplary method 300 may include additional blocks, fewer blocks, different blocks, or differently arranged blocks than those depicted in FIG. 3. Additionally, or alternatively, two or more of the blocks of the exemplary method 300 may be performed in parallel.

### Exemplary Process for Providing Real-Time Connected System Solutions

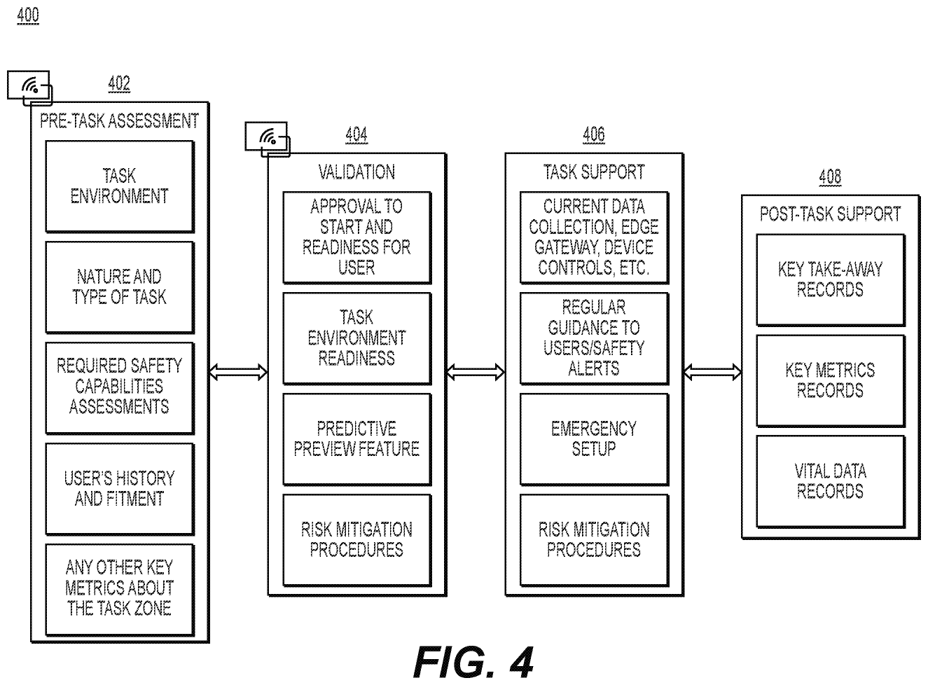

FIG. 4 illustrates an exemplary process 400 for providing real-time connected system solutions, according to one or more embodiments. Notably, process 400 may be performed by one or more processors of a server that is in communication with one or more user devices and other external system(s) via a network. However, it should be noted that process 400 may be performed by any one or more of the server, one or more user devices, or other external systems. Exemplary process 400 may be executed on one or more components of FIGS. 1, 2A, and/or 2B.

The process may include a pre-task assessment 402, where a system may receive data corresponding to a task environment, the nature and/or type of task, the required safety capabilities assessments, a user's history and fitness, and/or any other key metrics about the task zone. The data corresponding to the task environment may include data that describes the physical environment where the user may execute the task. For example, the task environment data may include data that describes potential hazards of the environment (e.g., extreme temperatures, hazardous location, radiation exposure, chemical processing), whether the environment includes one or more physical locations (e.g., whether the user may have to go to multiple locations to complete the task), details of such physical locations, and the like. The nature and/or type of task may describe the particular type of task to be completed, how the task may be completed (e.g., physically lifting materials), physical requirements of the user completing the task (e.g., the ability to lift over fifty pounds), and the like. The required safety capabilities assessments may include information regarding required and/or suggested safety equipment or wearables. For example, the system may include at least one database that stores one or more records for each piece of safety equipment and/or wearables. The one or more records may include data that indicates the type of tasks where the safety equipment and/or wearables should be worn. The user's history and fitment may include information regarding one or more user's work history (e.g., the types of tasks the user previously completed, human resource (HR) data, employment history) and information regarding the one or more user's fitness (e.g., how much weight the user can lift, any mobility issues of the user, recent issues, and any other information that may impact the user's physical limitations). The received data may also include any other key metrics about the task zone.

During the pre-task assessment 402, the system may assess all of the received data to determine recommendations for which safety equipment/wearables should be worn by the user while performing the task. The system may also determine, based on the received data, which user should perform a specific task. Additionally, based on the received data, the system may determine particular user requirements and/or system requirements in order for the task to be completed in a safe manner. For example, the system may determine that the task should be completed during a particular time of day, on a particular date (e.g., to avoid poor weather), that multiple users are needed to complete the task, and the like.

The process may also include validation 404, where the system may validate and grant approval for the user to start the task, determine the task environment readiness, provide a predictive preview feature, and/or validate risk mitigation procedures. The system may receive additional data and then compare the received data against the additional data to determine whether to grant approval for the user to begin to complete the task. The system may also use the received additional data to determine whether the task environment is ready for the user to begin the task. The system may also provide a predictive preview feature, which may include displaying one or more graphics that indicate how the task may be physically carried out (e.g., the correct posture to lift boxes). For example, the one or more graphics may be displayed on a device. The system may also validate particular risk mitigation procedures, such as validating particular safety equipment and/or wearables for the user to use and/or wear while performing the task.

The process may also include task support 406, where the system may provide real-time task support to the at least one user. The task support may include current data collection from an edge gateway, device controls, and the like. For example, the current data may be collected in real-time from one or more devices of the system. The current data may include the user's vital data (e.g., heart rate, temperature) as the user completes the task, data of how the user is performing the task (e.g., the user's posture), and/or environment data (e.g., temperature increase). The task support may also include regular guidance and/or safety alerts to the user. For example, the system may provide guidance and/or safety alerts to the user in response to determining that the current data indicates a potential safety issue (e.g., the user's heart rate is above normal, the user has improper posture). The system may convey the guidance and/or safety alerts to the user via one or more user interfaces (e.g., a display at the location of where the task is being completed, a display on the user's mobile device). The task support may also include an emergency setup. For example, the current data may indicate that the user has an issue, where the system may contact assistance services to help the user. The task support may also include risk mitigation procedures. For example, in response to an accident at the task location, the system may modify the scheduled timing of other tasks that are to be completed at the same task location.

The process may also include post-task support 408, where the system may provide key take-away records, key metrics records, and/or vital data records to one or more displays and/or one or more logs. The key take-away records may include safety information corresponding to how to improve the execution of future similar tasks (e.g., update the database records regarding which safety equipment and/or wearables should be used for future similar tasks), as well as whether the user should be scheduled to complete similar tasks in the future (e.g., whether the user was able to physically complete the task). The key metrics records may include information regarding how the user completed the task (e.g., how long the task took to complete), as well as describe the task environment (e.g., any unexpected hazards that arose during completion of the task). The vital data records may include information corresponding to the user's vitals (e.g., heartrate, temperature) as the user executed the task. For example, the user's vital information may be captured by one or more wearables worn by the user.

Although FIG. 4 shows example blocks of exemplary process 400, in some implementations, the exemplary process 400 may include additional blocks, fewer blocks, different blocks, or differently arranged blocks than those depicted in FIG. 4 Additionally, or alternatively, two or more of the blocks of the exemplary process 400 may be performed in parallel.

### Exemplary Method for Identifying One or More Alerts for a Connected System

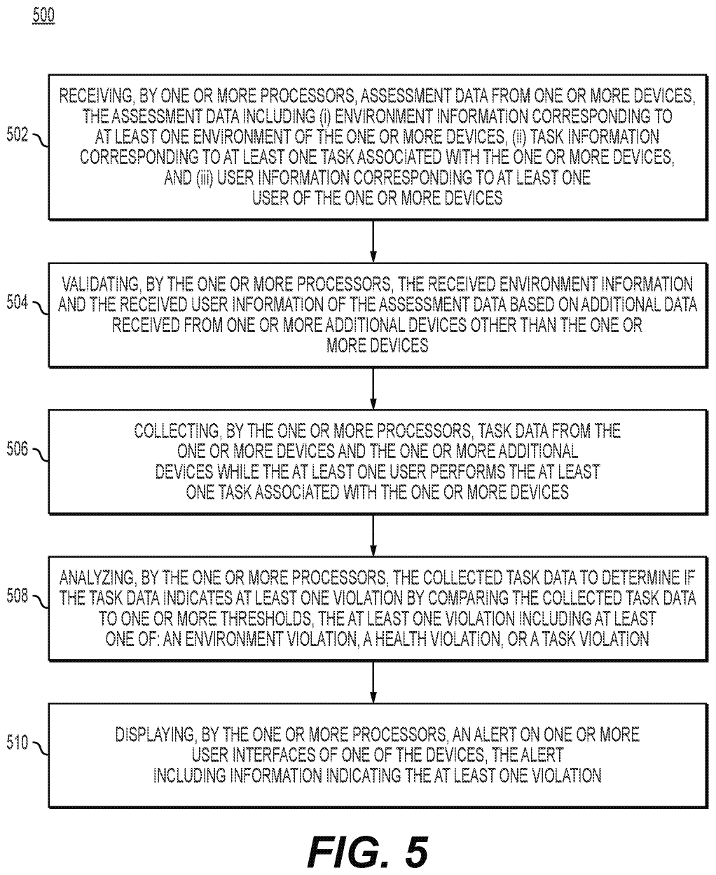

FIG. 5 illustrates an exemplary method 500 for identifying one or more alerts relating to a connected system, according to one or more embodiments. Notably, method 500 may be performed by one or more processors of a server that is in communication with one or more user devices and other external system(s) via a network. However, it should be noted that method 500 may be performed by any one or more of the server, one or more user devices, or other external systems. Exemplary method 500 may be executed on one or more components of FIGS. 1, 2A, and/or 2B.

The method may include receiving, by one or more processors, assessment data from one or more devices, the assessment data including (i) environment information corresponding to at least one environment of the one or more devices, (ii) task information corresponding to at least one task associated with the one or more devices, and (iii) user information corresponding to at least one user of the one or more devices (Step 502). The environment information may include information corresponding to various aspects of an environment for completing one or more tasks. The environment may include one or more physical locations, as well as one or more methods of transport for traveling between the physical locations (e.g., trucks, trains, and the like). Example environment information may include hazard information describing location hazards (e.g., temperature hazards), location information (e.g., GPS coordinates), the method of transporting between locations (e.g., trucks, trains, cars), attributes of the physical locations (e.g., item amount, item size, item weight, item type, physical barriers), and the like. The task information may include information describing the type of task that may need to be completed. Example task information may include a task type (e.g., transporting items, creating items, modifying items, coordinating operations), a task duration (e.g., an approximate amount of time the task should take to complete), a task location (e.g., the physical location(s) of where the task should be executed), task hazard information (e.g., any identified hazards of completing the task), task safety recommendations (e.g., particular safety equipment and/or wearables that the user should wear while completing the task), task user requirements (e.g., the user needs to be able to lift a certain amount of weight, the user may need to be on his feet for a particular amount of time), and the like. The user information may include information describing one or more users. Example user information may include health information (e.g., how much weight the user can lift, any mobility issues of the user, recent issues, and any other information that may impact the user's physical limitations), HR information (e.g., employment history), and/or task history information (e.g., the types of tasks the user previously completed). The one or more devices may include one or more sensors, one or more mobile devices, one or more internal computing systems, and/or one or more external computing systems. The one or more devices may include one or more components of FIGS. 1, 2A, and/or 2B.

In some embodiments, the method may include assigning, by the one or more processors, the at least one task to the at least one user, the assigning based on the environment information, the task information and the user information. For example, the assigning may include determining the at least one user that may be best suited for completing the task described in the task information. The determining may include, for example, comparing the task user requirements to the user information to determine whether the user meets the task user requirements. If the task user requirements are met, the user may be assigned to the task. If the task user requirements are not met, a different user may be assigned to the task.

In some embodiments, the method may include analyzing, by the one or more processors, the assessment data to determine at least one wearable recommendation or equipment recommendation for the at least one task. For example, the method may include analyzing the hazard information, the task type, the task hazard information, the task safety recommendations, and the like, to determine one or more pieces of safety equipment and/or one or more wearables that the user should wear and/or use while completing the task. The analyzing may include accessing one or more databases that include one or more database records. The one or more database records may include information for the one or more pieces of safety equipment and/or one or more wearables. The information may include one or more tasks that the one or more pieces of safety equipment and/or one or more wearables should be worn by the user. The method may include retrieving at least one database record that corresponds to the at least one task, where the at least one database record may include at least one recommended piece of safety equipment and/or wearable that the user should wear and/or use while completing the task.

The method may include validating, by the one or more processors, the received environment information and the received user information of the assessment data based on additional data received from one or more additional devices other than the one or more devices (Step 504). The additional data may include additional environment information, additional task information, and/or additional user information. For example, the additional data may have been received from one or more additional devices that are different from the initial one or more devices.

The validating may include comparing the assessment data to the additional data to determine whether the received environment information and the received user information are similar. If the assessment data and the additional data are similar, the method may include approving the received environment information and the received user information. If the assessment data and the additional data are similar regarding the received environment information but not similar regarding the received user information, the method may include only approving the received environment information, but not the received user information. If the assessment data and the additional data are similar regarding the received user information but not similar regarding the received environment information, the method may include only approving the received user information, but not the received environment information. If the assessment data and the additional data are not similar regarding the received environment information and the received user information, the method may include not approving the received environment information or the received user information. Approving the received environment information may indicate that the environment is ready for the task to begin. Additionally, approving the received user information may indicate that the user is ready to begin the task.

The method may include collecting, by the one or more processors, task data from the one or more devices and the one or more additional devices while the at least one user performs the at least one task associated with the one or more devices (Step 506). For example, the collected task data may also be collected from one or more wearables worn by the user while the user completes the at least one task. The collected task data may include information corresponding to the status of the task, how the user completes the task (e.g., the user's posture), health information of the user as he completes the task (e.g., the user's heart rate), environment changes during the task completion (e.g., new hazards that may arise), and the like.

The method may include analyzing, by the one or more processors, the collected task data to determine if the collected task data indicates at least one violation by comparing the collected task data to one or more thresholds, the at least one violation including at least one of: an environment violation, a health violation, or a task violation (Step 508). The one or more thresholds may include at least one of: an environmental threshold, a health threshold, or a task threshold. For example, the environmental threshold may indicate a threshold of when the environmental conditions have change and are deemed unsafe (e.g., an environment violation). The health threshold may indicate a threshold of when the user's health has changed and is deemed suboptimal (e.g., a health violation). The task threshold may indicate a threshold of when the task is unable to be completed (e.g., a task violation).

The analyzing the collected task data may include a machine-learning model analyzing the task data to determine whether the task data is within an acceptable range. The task data may include data corresponding to the environment, the user, and/or the task. In some embodiments, the machine-learning model may have been trained to determine acceptable ranges for task data for different types of tasks, where the task data may include information identifying at least one task. The trained machine-learning model may then analyze the task data to determine a specific acceptable range for the specific task, and then determine whether the task data is within the acceptable range. In some embodiments, the machine-learning model may have been trained to determine acceptable ranges for the user's health information (e.g., the user's heartrate) for different types of tasks, where the task data may include the user's health information, and information identifying the at least one task. The trained machine-learning model may then analyze the task data to determine a specific acceptable range for the user's health information for the specific task, and then determine whether the task data is within the acceptable range. Additionally, in response to determining that the task data is not within the acceptable range, displaying, by the one or more processors, a notification on the one or more user interfaces of the one or more user interfaces of one of the devices, the notification indicating that the task data is not within the acceptable range.

The method may include displaying, by the one or more processors, one or more alerts on one or more user interfaces of one of the devices, the alert including information indicating the at least one violation (Step 510). For example, the alert may include the details (e.g., location, time, users involved) of the at least one violation. In some embodiments, the alert may include guidance to eliminate any possible post-task risks, such as fatigue, imbalance, and/or physical discomforts. For example, such guidance may be determined through one or more post data processing algorithms that were applied to the collected task data. In some embodiments, the one or more alerts may be logged in one or more data stores for output at a later time.

In some embodiments, the method may include determining, by the one or more processors, whether the at least one task has been completed. For example, a notification, which may indicate that the task has been completed, may be received upon completion of the task. Additionally, or alternatively, the determining may include tracking the progression of the task using the collected task data. The method may also include, in response to determining that the at least one task has been completed, displaying, by the one or more processors, at least one record corresponding to the at least one task on the one or more user interfaces of one of the devices. The at least one record may include metric information and/or vital data information. The metric information may include information regarding how the user completed the task (e.g., how long the task took to complete), as well as describe the task environment (e.g., any unexpected hazards that arose during completion of the task). The vital data information may include information corresponding to the user's vitals (e.g., heartrate, temperature) as the user executed the task. For example, the user's vital information may be captured by one or more wearables worn by the user.

Although FIG. 5 shows example blocks of exemplary method 500, in some implementations, the exemplary method 500 may include additional blocks, fewer blocks, different blocks, or differently arranged blocks than those depicted in FIG. 5. Additionally, or alternatively, two or more of the blocks of the exemplary method 500 may be performed in parallel.

### Exemplary Architecture

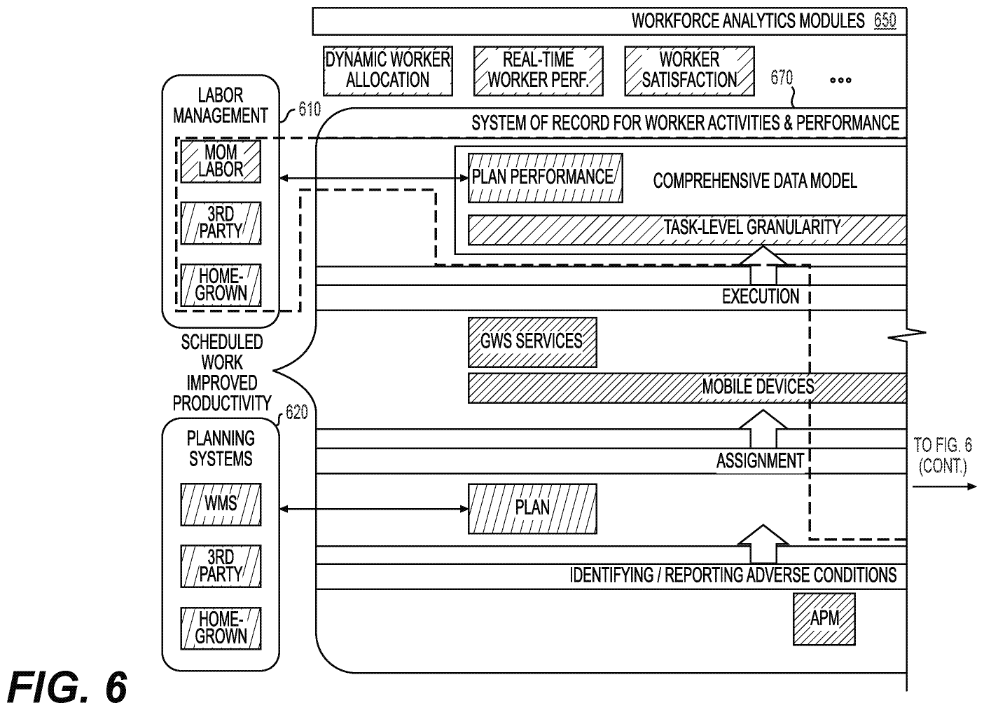

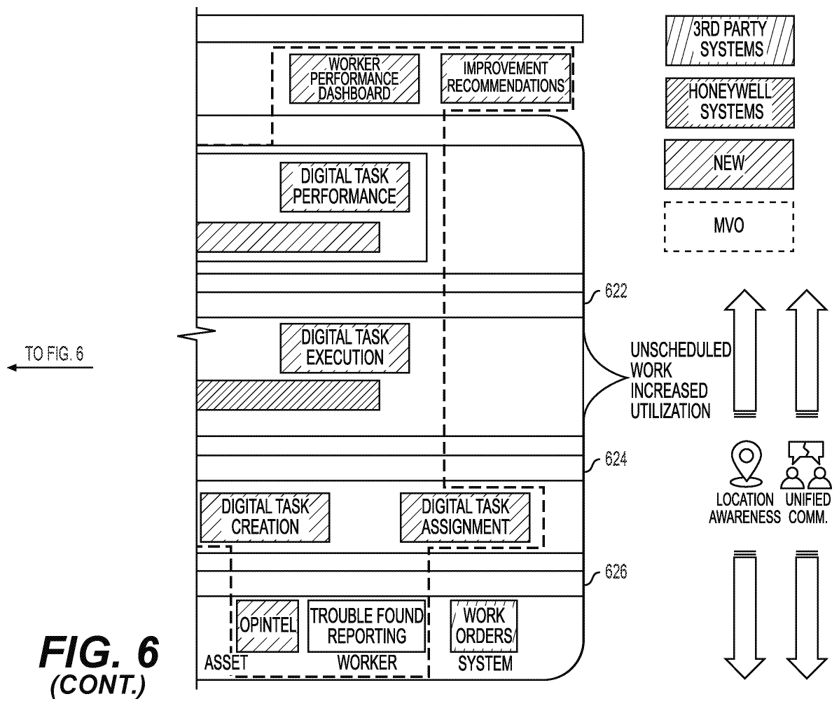

FIG. 6 is a diagram of architecture associated with a connected warehouse system 600, according to one or more embodiments. System 600 may include workforce analytic modules 615, including, but not limited to, modules for dynamic work allocation, real-time worker performance metrics, worker satisfaction, and the like. Workforce analytic modules 615 may also include one or more worker performance dashboards 623 and improvement recommendations 625. Improvement recommendations 625 may be for training, rewarding, coaching, engagement, and the like.

In certain aspects, worker performance dashboards 623 and improvement recommendations 625 may be updated (e.g., in real-time) by a system 617 of record for worker activities and performance. System 617 may be in communication with workforce analytic modules 615. System 617 may improve scheduled worked productivity via labor management module 610 and/or planning systems module 620. Specifically, management module 610 may include one or more discrete components (e.g., components to manage manufacturing operations management (MOM) labor, third party activities, as well as homegrown activities) that in real-time communicate with a comprehensive data model of system 617. The comprehensive data model of system 617 may include a plan performance module bi-directionally coupled to labor management module 610. The comprehensive data model of system 617 may also include modules with digital task performance and task-level granularity. In some aspects, the plan performance module may include a database of worker digital task performance and task-level granularity (e.g., showing discrete subtasks of a task or granular performance metrics of a respective worker task).

In practice, a layer 626 for identifying and reporting adverse conditions may be included in system 617. Layer 626 may include an asset performance manager (APM), as well as systems to manage worker orders. In some aspects, layer 626 may include an operation intel manager and trouble-found reporting system that collectively work to enable layer 626 to communicate with aspects of assignment layer 624 downstream thereof. Layer 626 may include a plan system in bi-directionally coupled to planning systems module 620, including but not limited to warehouse management systems (WMS), third party systems, and the like. The operation intel manager and trouble-found of assignment layer 626 may communicate with digital task creation and digital task assignment systems of assignment layer 624. Assignment layer 624 may communicate with aspects of execution layer 622 downstream thereof.

Layer 622 may include, or be coupled to, one or more mobile devices (e.g., mobile devices of users and/or personnel associated therewith including employees, managers, and personnel of third parties). Layer 622 may also include guided work software (GWS) systems. In some aspects, the digital task creation and digital task assignment systems of assignment layer 624 may be in communication with the mobile devices of layer 622, as well as a digital task execution system of layer 622. In some examples, mobile devices of layer 622, as well as a digital task execution system of layer 622, may communicate with the task level granularity system, the plan performance system, and/or digital task performance system of the comprehensive data model of system 617 to dynamically update worker performance dashboard 623 and improvement recommendations 625.

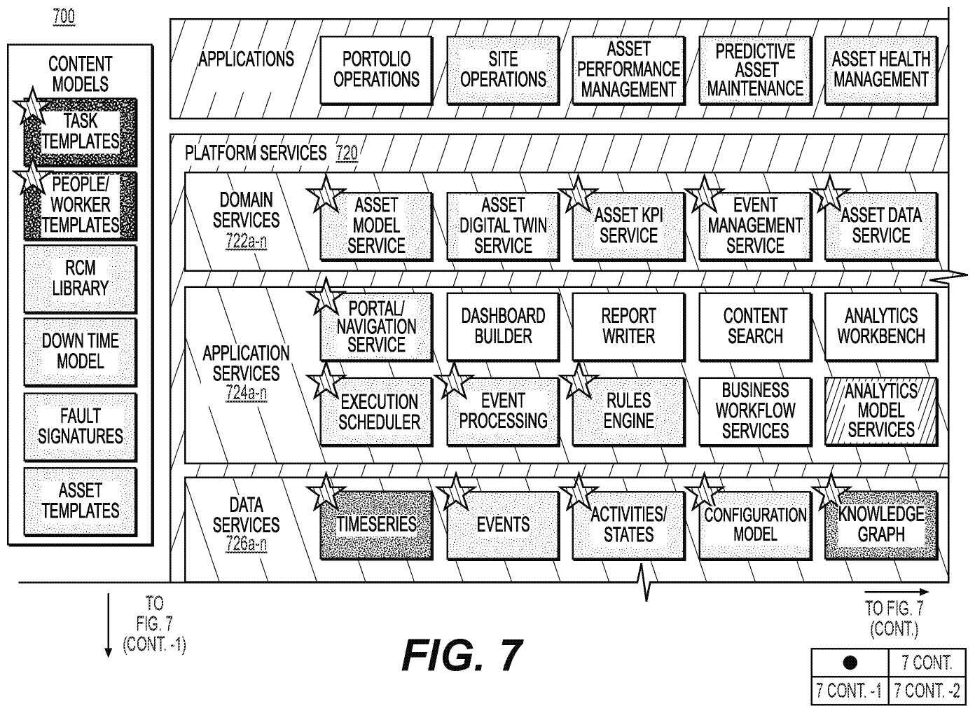

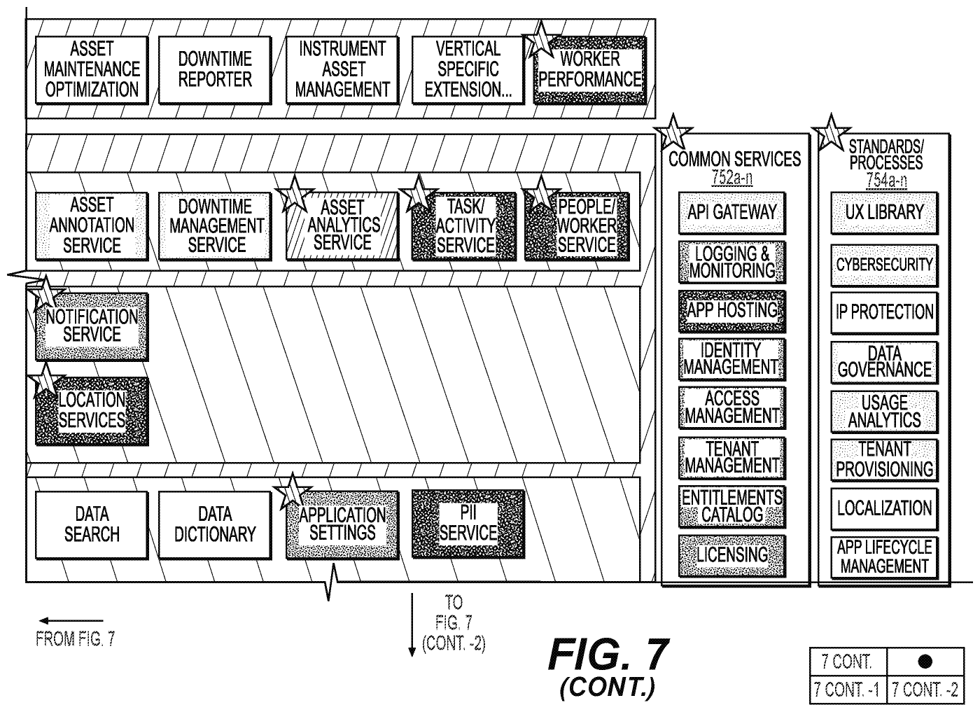

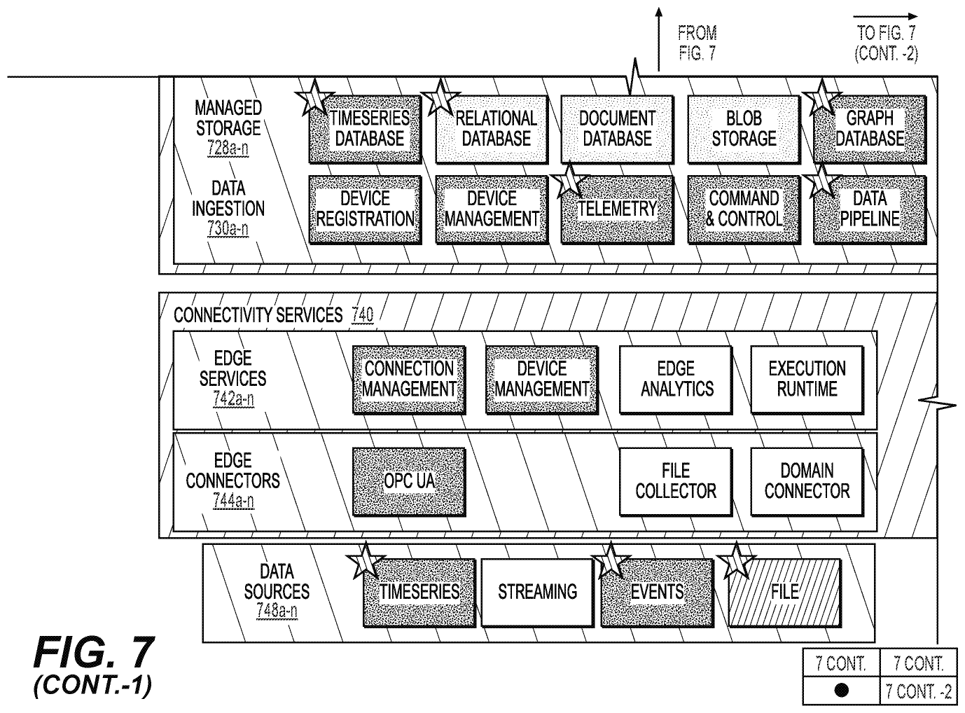

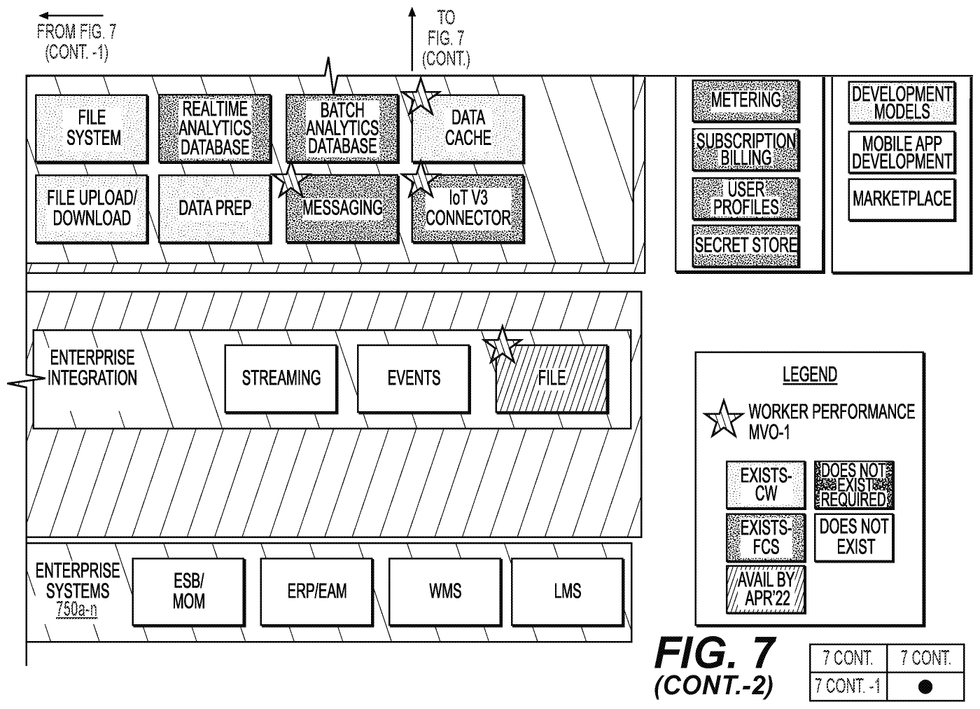

FIG. 7 is a diagram of architecture of a connected warehouse system 700, according to one or more embodiments. System 700 may be a multi-layered system that may include an applications layer 710, a platform services layer 720, a common services layer 752a-n, a standards and processes layer 754a-n, a connectivity services layer 740, a data sources layer 748a-n, and an enterprise systems layer 750a-n.

Applications layer 710 can include a plurality of components such as applications for portfolio operations, site operations, asset performance management, predictive asset maintenance, asset health management, asset maintenance optimization, downtime reporter, instrument asset management, vertical specific extension, and worker performance.

Platform services layer 720 can be in communication with applications layer 710 and include a plurality of system components, including domain services 722a-n, application services 724a-n, data services 726a-n, managed storage 728a-n, and/or data ingestion 730a-n. Domain services 722a-n may include modules and/or components for asset model service, asset digital service, asset key performance indicator (KPI) service, event management service, asset data service, asset annotation service, downtime management service, asset analytics service, task/activity service, and/or people worker service. Preferably, domain services 722a-n may include asset analytics service systems, task/activity service systems, and/or people worker service systems.

Application services 724a-n may include modules and/or components for portal navigation service, dashboard builder, report writer, content search, analytics workbench, notification service, execution scheduler, event processing, rules engine, business workflow services, analytics model services, and/or location services. Some or all of the components of application services 724a-n may be in communication with the applications of layer 710.

Data services 726a-n may include modules and/or components for time series, events, activities and states, configuration model, knowledge graph, data search, data dictionary, application settings, and/or personal identifying information (PII) services. Managed storage services 728a-n may include databases for time series, relational, document, blob storage, graph databases, file systems, real-time analytics databases, batch analytics databases, and/or data caches. Managed storage services 730a-n may include modules and/or components for device registration, device management, telemetry, command and control, data pipeline, file upload/download, data prep, messaging, and/or IoT V3 connection.

Connectivity services layer 740 may include edge services 742a-n, edge connectors 744a-n, and/or enterprise integration 746a-n. Edge services 742a-n may include modules and/or components for connection management, device management, edge analytics, and/or execution runtime. Edge connectors 744a-n may include OPC unified architecture (OPC UA), file collectors, and/or domain connectors. Enterprise integration 746a-n may include modules and/or components for streaming, events, and/or files. Data sources layer 748a-n may include modules and/or components for streaming, events, and/or files, as well as time series.

In some embodiments, common services 752a-n may include one or more API gateways, as well as components for logging and monitoring, application hosting, identify management, access management, tenant management, entitlements catalogues, licensing, metering, subscription billing, user profiles, and/or secret store.

In some embodiments, standards and processes 754a-n may include one or more UX libraries, as well as components for cybersecurity, IP protection, data governance, usage analytics, tenant provisioning, localization, app lifecycle management, deployment models, mobile app development, and/or marketplace.

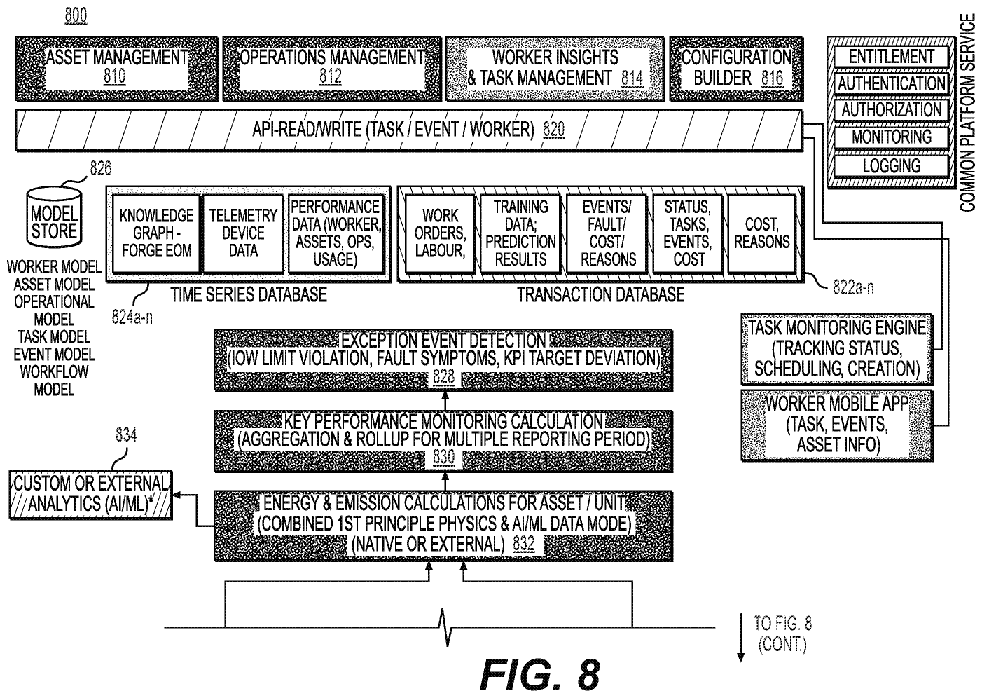

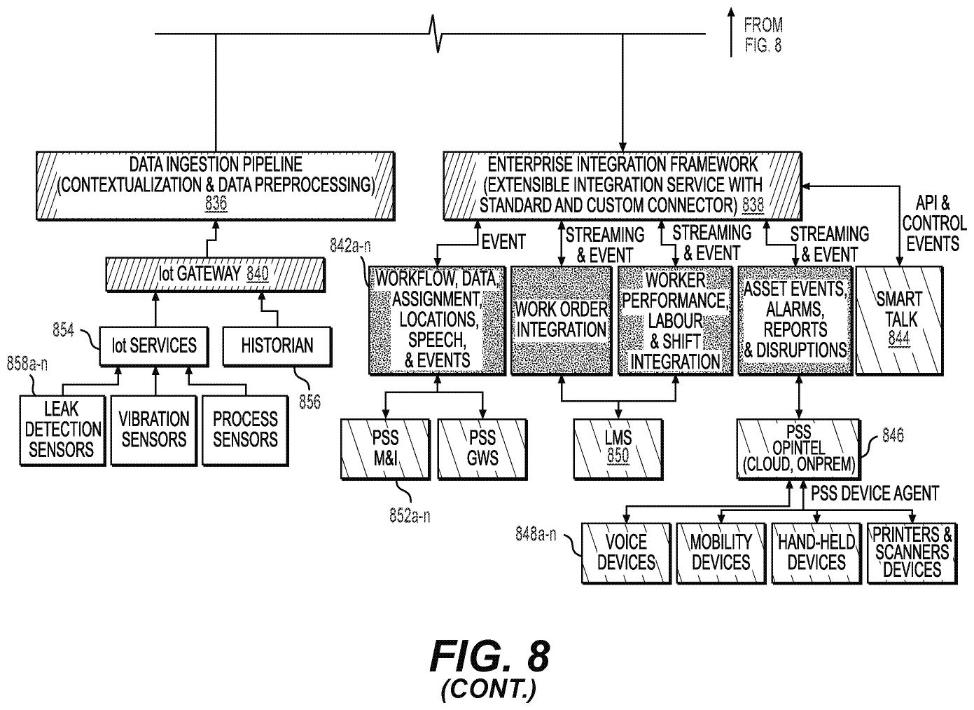

FIG. 8 depicts a schematic block diagram of a framework of a platform of a connected warehouse system 800, according to one or more embodiments. System 800 may include an asset management system 810, operations management system 812, worker insights and task management system 814, and/or configuration builder system 816. Each of systems 810, 812, 814, and 816 may be in communication with API 820, whereby API 820 may be configured to read/write tasks, events, and/or otherwise coordinate working with workers of system 800. API 820 may include a task monitoring engine configured to track status, schedule, and/or facilitate task creation. API 820 may present or otherwise be accessed via a worker mobile application (e.g., a graphical user interview on a computing device) to similarly present and manage operations related to tasks, events, and asset information.

API 820 may be communication with model store 826, whereby model store 826 may include models such as worker models, asset models, operational models, task models, event models, workflow models, and the like. API 820 may be in communication with time series databases 824a-n and/or transaction databases 822a-n. Time series databases 824a-n may include knowledge databases, graph databases, as well as extensible object models (EOMs). Transaction databases 822a-n may include components and/or modules for work orders, labor, training data, prediction results, events, fault, costs, reasons, status, tasks, events, and/or reasons.

Each of databases 824a-n, 822a-n may be in communication with analytics model 834, which may be a machine learning model that effectively processes, analyzes, and classifies operations of system 800. Model 834 may be a trained machine learning system having been trained using a learned set of parameters to predict one or more learned performance parameters of system 800. Learned parameters may include, but are not limited to, predictive asset maintenance of a connected warehouse, asset health management, asset maintenance optimization, worker downtime reporter, instrument asset management, vertical specific extension, and/or worker performance. One or more corrective actions may be taken in response to predictions rendered by model 834. Model 834 may be trained with a regression loss (e.g., mean squared error loss, Huber loss, etc.) and for binary index values it may be trained with a classification loss (e.g., hinge, log loss, etc.). Machine learning systems that may be trained include, but are not limited to, a convolutional neural network (CNN) trained directly with the appropriate loss function, CNN with layers with the appropriate loss function, capsule network with the appropriate loss function, transformer network with the appropriate loss function, multiple instance learning with a CNN (for a binary resistance index value), multiple instance regression with a CNN (for a continuous resistance index value), and the like.

In certain aspects, databases 824a-n and 822a-n may operate together to perform exception event detection 828. Exception event detection 828 may utilize data from one or more data sources to detect low limit violations, fault symptoms, KPI target deviations, and the like. In certain aspects of exception event detection 828, a data ingestion pipeline 836 and enterprise integration framework 838 may exchange information for energy and emission calculations per asset/units of system 800. Pipeline 836 may utilize contextual data and data preprocessing, while framework 838 may include extensible integration service with standard and customer connectors.

In certain embodiments, an IoT gateway 840 may be communicatively coupled to pipeline 836. IoT gateway 840 can be communicatively coupled to IoT devices 854 such as sensors 858a-n, including leak detection sensors, vibration sensors, process sensors, and/or the like. IoT gateway 840 may also be in communication with data historian 856 that includes historical data related to the warehouse.

Framework 838 may be in communication with event manager modules 842a-n, including workflow module, work order integration module, worker performance module, asset event module, and the like. For events, the workflow module may be configured to bidirectionally communicate with framework 838 and/or components of process workflow data 852a-n, including Process Safety Suite (PSS) maintenance and inspection (M&I) and PSS GWS. For event streaming, work order integration module and worker performance module may both be configured to bidirectionally communicate with framework 838 and labor management systems (LMS) 850. In some embodiments, the event streaming asset event module may also be configured to bidirectionally communicate with PSS operational intelligence systems 846 and framework 838. PSS operational intelligence systems 846 in turn may be cloud-based and/or on premises and bidirectionally communicate with devices 848a-n, including voice devices, mobility devices, hand-held devices, printers, scanners, and/or the like. Framework 838 can also be in communication with start talk module 844 for corresponding API and event control.

In embodiments of system 800, pipeline 836 and framework 838 may work together to perform step 832 to calculate energy and emission calculations for assets and/or associated units. Model 834 may be used in performing step 832 as well as other native and/or external models connected therewith, whereby step 832 may utilize data received from pipeline 836 and framework 838.

Upon completing step 832, key performance monitoring calculations may be performed in step 830. Step 830 may be performed based on energy and emission calculations from step 832 by aggregating and rolling up across one or multiple reporting periods. Upon performing step 830, the aforementioned event exception detection step 828 may be performed to detect exception events. In some aspects, step 828 may be performed based on the key performance monitoring calculations of step 830.

### Exemplary Device

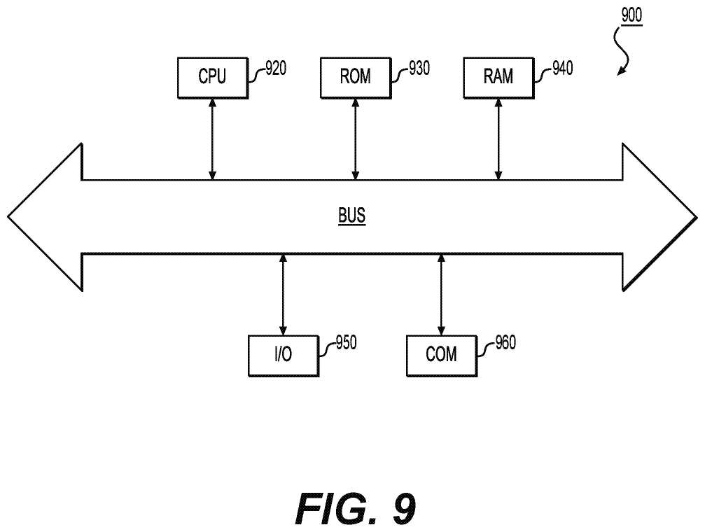

FIG. 9 is a simplified functional block diagram of a computer 900 that may be configured as a device for executing the methods of FIGS. 4-5, according to exemplary embodiments of the present disclosure. For example, device 900 may include a central processing unit (CPU) 920. CPU 920 may be any type of processor device including, for example, any type of special purpose or a general-purpose microprocessor device. As will be appreciated by persons skilled in the relevant art, CPU 920 also may be a single processor in a multi-core/multiprocessor system, such system operating alone, or in a cluster of computing devices operating in a cluster or server farm. CPU 920 may be connected to a data communication infrastructure 910, for example, a bus, message queue, network, or multi-core message-passing scheme.

Device 900 also may include a main memory 940, for example, random access memory (RAM), and also may include a secondary memory 930. Secondary memory 930, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 930 may include other similar means for allowing computer programs or other instructions to be loaded into device 900. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 900.

Device 900 also may include a communications interface (“COM”) 960. Communications interface 960 allows software and data to be transferred between device 900 and external devices. Communications interface 960 may include a modem, a network interface (such as an Ethernet card), a communications port, a PCMCIA slot and card, or the like. Software and data transferred via communications interface 960 may be in the form of signals, which may be electronic, electromagnetic, optical, or other signals capable of being received by communications interface 960. These signals may be provided to communications interface 960 via a communications path of device 900, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 900 also may include input and output ports 950 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for identifying one or more alerts relating to a connected system, the method comprising:
receiving, by one or more processors, assessment data from one or more devices, the assessment data including (i) environment information corresponding to at least one environment of the one or more devices, (ii) task information corresponding to at least one task associated with the one or more devices, and (iii) user information corresponding to at least one user of the one or more devices;
validating, by the one or more processors, the received environment information and the received user information of the assessment data based on additional data received from one or more additional devices other than the one or more devices;
collecting, by the one or more processors, task data from the one or more devices and the one or more additional devices while the at least one user performs the at least one task associated with the one or more devices;
analyzing, by the one or more processors, the collected task data to determine if the collected task data indicates at least one violation by comparing the collected task data to one or more thresholds, the at least one violation including at least one of: an environment violation or a health violation, or a task violation; and
displaying, by the one or more processors, one or more alerts on one or more user interfaces of one of the devices, the one or more alerts including information indicating the at least one violation.

2. The computer-implemented method of claim 1, wherein the analyzing the collected task data includes a machine-learning model analyzing the collected task data to determine whether the collected task data is within an acceptable range.

3. The computer-implemented method of claim 2, the method further comprising:
in response to determining that the collected task data is not within the acceptable range, displaying, by the one or more processors, a notification on the one or more user interfaces of the one or more user interfaces of one of the devices, the notification indicating that the collected task data is not within the acceptable range.

4. The computer-implemented method of claim 1, the method further comprising:
determining, by the one or more processors, whether the at least one task has been completed; and
in response to determining that the at least one task has been completed, displaying, by the one or more processors, at least one record corresponding to the at least one task on the one or more user interfaces of one of the devices.

5. The computer-implemented method of claim 1, the method further comprising:
assigning, by the one or more processors, the at least one task to the at least one user, the assigning based on the environment information, the task information, and the user information.

6. The computer-implemented method of claim 1, the method further comprising:
analyzing, by the one or more processors, the assessment data to determine at least one wearable recommendation or equipment recommendation for the at least one task.

7. The computer-implemented method of claim 1, wherein the one or more devices include one or more sensors, one or more mobile devices, one or more internal computing systems, and/or one or more external computing systems.

8. The computer-implemented method of claim 1, wherein the additional data includes additional environment information, additional task information, or additional user information.

9. The computer-implemented method of claim 1, wherein the one or more thresholds includes at least one of an environmental threshold, a health threshold, or a task threshold.

10. A computer system for identifying one or more alerts relating to a connected system, the computer system comprising:
a memory having processor-readable instructions stored therein; and
one or more processors configured to access the memory and execute the processor-readable instructions, which when executed by the one or more processors configures the one or more processors to perform a plurality of functions, including functions for:
receiving assessment data from one or more devices, the assessment data including (i) environment information corresponding to at least one environment of the one or more devices, (ii) task information corresponding to at least one task associated with the one or more devices, and (iii) user information corresponding to at least one user of the one or more devices;
validating the received environment information and the received user information of the assessment data based on additional data received from one or more additional devices other than the one or more devices;
collecting task data from the one or more devices and the one or more additional devices while the at least one user performs the at least one task associated with the one or more devices;
analyzing the collected task data to determine if the task data indicates at least one violation by comparing the collected task data to one or more thresholds, the at least one violation including at least one of: an environment violation, a health violation, or a task violation; and
displaying one or more alerts on one or more user interfaces of one of the devices, the one or more alerts including information indicating the at least one violation.

11. The computer system of claim 10, wherein the analyzing the collected task data includes a machine-learning model analyzing the collected task data to determine whether the collected task data is within an acceptable range.

12. The computer system of claim 11, the functions further comprising:
in response to determining that the collected task data is not within the acceptable range, displaying a notification on the one or more user interfaces of one of the devices, the notification indicating that the collected task data is not within the acceptable range.

13. The computer system of claim 10, the functions further comprising:
determining whether the at least one task has been completed; and
in response to determining that the at least one task has been completed, displaying at least one record corresponding to the at least one task on the one or more user interfaces of one of the devices.

14. The computer system of claim 10, the functions further comprising:
assigning the at least one task to the at least one user, the assigning based on the environment information, the task information and the user information.

15. The computer system of claim 10, the functions further comprising:
analyzing the assessment data to determine at least one wearable recommendation or equipment recommendation for the at least one task.

16. The computer system of claim 10, wherein the one or more devices include one or more sensors, one or more mobile devices, one or more internal computing systems, and/or one or more external computing systems.

17. A non-transitory computer-readable medium containing instructions for identifying one or more alerts relating to a connected system, the instructions comprising:
receiving assessment data from one or more devices, the assessment data including (i) environment information corresponding to at least one environment of the one or more devices, (ii) task information corresponding to at least one task associated with the one or more devices, and (iii) user information corresponding to at least one user of the one or more devices;
validating the received environment information and the received user information of the assessment data based on additional data received from one or more additional devices other than the one or more devices;
collecting task data from the one or more devices and the one or more additional devices while the at least one user performs the at least one task associated with the one or more devices;
analyzing the collected task data to determine if the task data indicates at least one violation by comparing the collected task data to one or more thresholds, the at least one violation including at least one of: an environment violation, a health violation, or a task violation; and
displaying one or more alerts on one or more user interfaces of one of the devices, the one or more alerts including information indicating the at least one violation.

18. The non-transitory computer-readable medium of claim 17, wherein the analyzing the collected task data includes a machine-learning model analyzing the collected task data to determine whether the collected task data is within an acceptable range.

19. The non-transitory computer-readable medium of claim 18, the instructions further comprising:
in response to determining that the collected task data is not within the acceptable range, displaying a notification on the one or more user interfaces of one of the devices, the notification indicating that the collected task data is not within the acceptable range.

20. The non-transitory computer-readable medium of claim 17, the instructions further comprising:
determining whether the at least one task has been completed; and
in response to determining that the at least one task has been completed, displaying at least one record corresponding to the at least one task on the one or more user interfaces of one of the devices.
